(19) United States
(12) Patent Application Publication
(10) Pub. No.: US 2001/0018667 A1
(43) Pub. Date: Aug. 30, 2001

(54) System for advertising on a network by displaying advertisement objects in a virtual three-dimensional area

(76) Inventor: Yang Shin Kim, Seoul (KR)

Correspondence Address: eFirm, Ltd., 1725 DeSales St., N.W., Washington, DC, 20036, US

(21) Appl. No.: 09/778,811

(22) Filed: Feb. 8, 2001

(30) Foreign Application Priority Data
Feb. 29, 2000 (KR) 2000-10127

(51) Int. Cl. G06F 17/60

(52) U.S. Cl. 705/14

(57) ABSTRACT

An advertising method on a network comprises displaying a plurality of advertisement objects in a virtual three-dimensional area, and allowing a user to select at least one of the plurality of advertisement objects. Moreover, the present invention relates to an advertisement method of additionally displaying a representation of a user, wherein the representation can be used by the user to move around the virtual three-dimensional area and to select at least one of the plurality of objects. Particularly, an Internet advertisement system uses virtual reality spaces based on three-dimensional graphics, wherein three-dimensional virtual reality programs are provided through an Internet home page. Also, virtual Web signboards, virtual Web advertising balloons (ad-balloons) and virtual Web shops move in a three-dimensional perspective representation manner with the movement of a specific character within a selected one of the virtual reality spaces as if they were really present around the character. This up-to-date advertisement technique is very effective in attracting consumers' attention and enabling consumers to have a higher respectable degree of recognition of advertisements on the Internet.

This application is related to and claims priority from Korean Patent Application No. 2000-10127, filed Feb. 29, 2000, which is incorporated herein by reference in its entirety.

### BACKGROUND OF THE INVENTION

1. Technical Field

The present invention relates to an advertising method on a network, comprising displaying a plurality of advertisement objects in a virtual three-dimensional area, and allowing a user to select at least one of the plurality of advertisement objects. Moreover, the present invention relates to an advertisement method of additionally displaying a representation of a user, wherein the representation can be used by the user to move around the virtual three-dimensional area and to select at least one of the plurality of objects.

The present invention has particular application as an Internet advertisement system. In one embodiment, an Internet advertisement system uses virtual reality spaces based on three-dimensional graphics, wherein three-dimensional virtual reality programs are provided through an Internet home page. Also, virtual Web signboards, virtual Web advertising balloons (ad-balloons) and virtual Web shops move in a three-dimensional perspective representation manner with the movement of a specific character within a selected one of the virtual reality spaces as if they were really present around the character. This up-to-date advertisement technique is very effective in attracting consumers' attention and enabling consumers to have a higher respectable degree of recognition of advertisements on the Internet.

2. Description of the Related Art

Recently, with the development of Internet business, a considerable number of commercial transactions have been made on-line over the Internet. For successful Internet commercial transactions, there is keen competition in regard to the price of commodities and the quality of services. This is because customers can easily and readily visit different sites on the Internet to retrieve and ascertain respective prices and respective qualities offered for the same commodity and the same service by different shopping malls in different sites.

Thus, it is of utmost importance to cyber shopping mall sites to induce customers to their shopping malls for deals. As a part of the customer inducement strategy, many of them offer customers cyber points to be accumulated as sort of credit or mileage, in proportion to the amount and the number of their purchases therein. The customers are allowed to use the accumulated cyber points to buy any products in the same or other shopping malls within the same site or to exchange them with real money if they choose to do so.

However, even if a merchandiser or manufacturer intends to sell or provide a commodity or service, the product or service is unable to be sold or provided to customers if its existence, selling place, and, etc. are not known to customers. Under these circumstances, even if the manufacturer or merchandiser is willing to sell or provide the commodity or service at the most competitive price or conditions, it may be difficult to sell or provide the commodity or service as much as he or she desires. As a result, a large number of advertisers attempt to advertise their websites or Web shopping malls in order to make their existence and commodities known to netizens through the advertisement.

One type of representative Internet advertisement is banner advertisement. Banner advertisement can usually be changed in size, flashed or scrolled, in order to arouse customers' interest therein.

Further, as a more advanced mode of advertisement, there is a method of paying customers compensation for viewing an advertisement. That is, if a customer clicks on an advertisement, he or she is paid a compensation for the advertisement viewing in cash or kind, or cyber points. By giving the customer the compensation for the advertisement viewing, an associated advertiser expects that his or her product or service be securely registered in the customer's memory.

However, unlike advertisers' expectations as mentioned above, only a small portion of customers are interested in gaining information on a specific commodity they desire to buy from the advertisement. Thus, the number of times that the concerned advertisement is actually hit on is very poor. A larger portion of customers is rather interested in gaining the compensation for viewing the advertisement as much as possible. Therefore, an advertisement planning is requested so as to enable customers to spontaneously view advertisements with interest or to recognize them in an unconscious manner, thereby ultimately securing potential customers.

### SUMMARY OF THE INVENTION

An object of the present invention is to provide a system for advertising on a network, comprising displaying a plurality of advertisement objects in a virtual three-dimensional area, and allowing a user to select at least one of the plurality of advertisement objects, thus providing a more distinctive and effective method of advertising.

In one embodiment of the present invention, an advertisement method on a network comprises displaying a plurality of advertisement objects in a virtual three-dimensional area; and allowing a user to select at least one of the plurality of advertisement objects.

In another embodiment of the present invention, an advertisement method on a network comprises displaying a plurality of advertisement objects in a virtual three-dimensional area; and allowing a user to select at least one of the plurality of advertisement objects; wherein the network is the Internet.

In another embodiment of the present invention, an advertisement method on a network comprises displaying a plurality of advertisement objects in a virtual three-dimensional area; and allowing a user to select at least one of the plurality of advertisement objects; wherein at least one of the plurality advertisement objects comprises information that an advertiser wants to advertise.

In another embodiment of the present invention, an advertisement method on a network comprises displaying a plurality of advertisement objects in a virtual three-dimensional area; allowing a user to select at least one of the plurality of advertisement objects; and moving at least one of the plurality of advertisement objects in the area.

In another embodiment of the present invention, an advertisement method on a network comprises displaying a plurality of advertisement objects in a virtual three-dimensional area; allowing a user to select at least one of the plurality of advertisement objects; and allowing the user to move in the area.

In another embodiment of the present invention, an advertisement method on a network comprises displaying a plurality of advertisement objects in a virtual three-dimensional area; allowing a user to select at least one of the plurality of advertisement objects; and displaying a representation of the user, wherein the representation can be used by the user to move around in the area and to select the at least one of the plurality of advertisement objects.

In another embodiment of the present invention, an advertisement method on a network comprises displaying a plurality of advertisement objects in a virtual three-dimensional area; allowing a user to select at least one of the plurality of advertisement objects; and displaying a plurality of representations, wherein each one of the plurality of representations corresponds to a respective one of a plurality users, and wherein each one of the plurality of representations can be used by a respective one of the plurality of users to move around in the area, to select at least one of the plurality of advertisement objects, and to communicate with another one of the plurality of users.

In another embodiment of the present invention, an advertisement method on a network comprises displaying a plurality of advertisement objects in a virtual three-dimensional area; allowing a user to select at least one of the plurality of advertisement objects; and displaying a representation of the user, wherein the representation can be used by the user to perform a plurality of functions.

In another embodiment of the present invention, an advertisement method on a network comprises displaying a plurality of advertisement objects in a virtual three-dimensional area; and allowing a user to select at least one of the plurality of advertisement objects; wherein at least one of the plurality advertisement objects comprises a plurality of goods or services. The method further comprises the step of allowing the user to purchase at least one of the plurality of goods or services.

In another embodiment of the present invention, an advertising apparatus on a network comprises a means for displaying a plurality of advertisement objects in a virtual three-dimensional area; and a means for allowing a user to select at least one of the plurality of advertisement objects.

In another embodiment of the present invention, a computer program stored on a computer-readable medium comprises the instructions of displaying a plurality of advertisement objects in a virtual three-dimensional area; and allowing a user to select at least one of the plurality of advertisement objects.

Moreover, the present invention has been made in view of the above-noted problems of the related art, and it is an object of the present invention to provide an Internet advertisement system using virtual reality spaces based on three-dimensional graphics wherein three-dimensional virtual reality programs are provided through an Internet home page, and virtual Web signboards, virtual Web ad-balloons and virtual Web shops move in a three-dimensional perspective representation manner with the movement of a specific character within a selected one of the virtual reality spaces as if they were really present around the character, thereby enabling customers to have a higher respectable degree of recognition of advertisements on the Internet.

Another object of the present invention is to provide an Internet advertisement system using virtual reality spaces based on three-dimensional graphics wherein advertisement posting elements such as three-dimensional signboards, ad-balloons or shops depicted in the virtual reality spaces are sold or leased to any advertisers who wish to plan and create advertisements at their disposal under the conditions agreed upon by an associated site operator and the respective advertisers, in order to freely and effectively represent features and characteristics of their products or services.

In accordance with the present invention, the above and other objects can be achieved by a provision of an Internet advertisement system using virtual reality spaces based on three-dimensional graphics, comprising a virtual reality program database for storing a plurality of three-dimensional virtual reality programs to be provided to a website; an advertisement database for storing three-dimensional advertisement information about a variety of products and services requested to be advertised by advertisers; and a Web server for providing the three-dimensional virtual reality programs stored in the virtual reality program database to the website to allow avatar characters of users participating in the virtual reality programs to act in virtual reality spaces defined respectively by the virtual reality programs and for moving virtual Web signboards, virtual Web ad-balloons and virtual Web shops in a three-dimensional perspective representation manner with the movement of the avatar characters within the virtual reality spaces as if they were really present around the avatar characters.

Preferably, the virtual Web signboards, Web ad-balloons and Web shops are sold or leased to the advertisers so that they can represent the advertisement information stored in the advertisement database in the three-dimensional graphics according to the conditions agreed upon by an operator of the website and the respective advertisers.

### BRIEF DESCRIPTION OF THE DRAWINGS

The aforementioned aspects and other features of the invention will be explained in the following description, taken in conjunction with the accompanying drawings wherein:

FIG. 1 is a diagram illustrating an embodiment of the present invention;

FIG. 2 illustrates an aspect of the embodiment of FIG. 1;

FIG. 3 is a diagram illustrating another embodiment of the present invention;

FIG. 4 illustrates an aspect of the embodiment of FIG. 3;

FIG. 5 is a diagram illustrating an embodiment of the present invention;

FIG. 6 illustrates an aspect of the embodiment of FIG. 5;

FIG. 7 is a diagram illustrating another embodiment of the present invention;

FIG. 8 illustrates an aspect of the embodiment of FIG. 7;

FIG. 9 is a diagram illustrating an embodiment of the present invention;

FIG. 10 illustrates an aspect of the embodiment of FIG. 9;

FIG. 11 is a diagram illustrating another embodiment of the present invention;

FIG. 12 illustrates an aspect of the embodiment of FIG. 11;

FIG. 13 is a diagram illustrating an embodiment of the present invention;

FIG. 14 illustrates an aspect of the embodiment of FIG. 13;

FIG. 15 is a diagram illustrating another embodiment of the present invention;

FIG. 16 illustrates an aspect of the embodiment of FIG. 15;

FIG. 17 is a diagram illustrating an embodiment of the present invention;

FIG. 18 illustrates an aspect of the embodiment of FIG. 17;

FIG. 19 is a diagram illustrating another embodiment of the present invention;

FIG. 20 is a diagram illustrating another embodiment of the present invention;

FIG. 21 is a block diagram showing the construction of an Internet advertisement system using virtual reality spaces based on three-dimensional graphics in accordance with the present invention;

FIG. 22 is a flowchart illustrating the operation of the Internet advertisement system in FIG. 1 in accordance with the present invention; and

FIGS. 23a through 23c are views showing exemplary pictures displayed on the Web by operating the Internet advertisement system in accordance with the present invention.

### DETAILED DESCRIPTION

The present invention will be described in detail, with reference to the accompanying drawings.

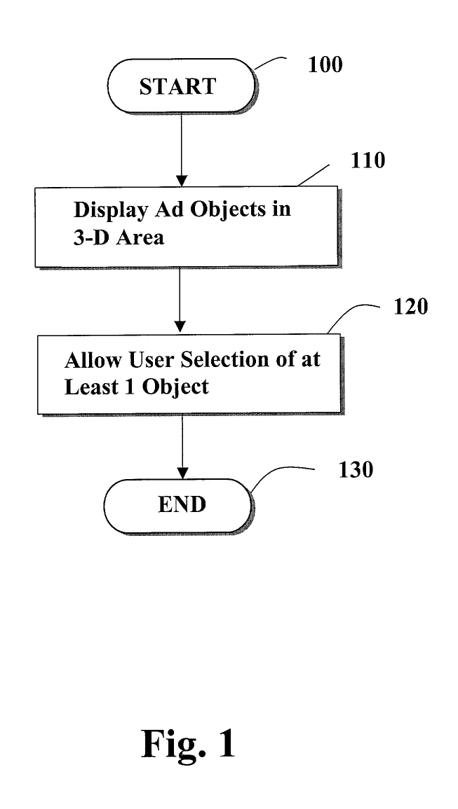

FIG. 1 shows an embodiment according to the present invention. An advertising method on a network comprises displaying a plurality of advertisement objects in a virtual three-dimensional area at step 110, and allowing a user to select at least one of the plurality of advertisement objects at step 120.

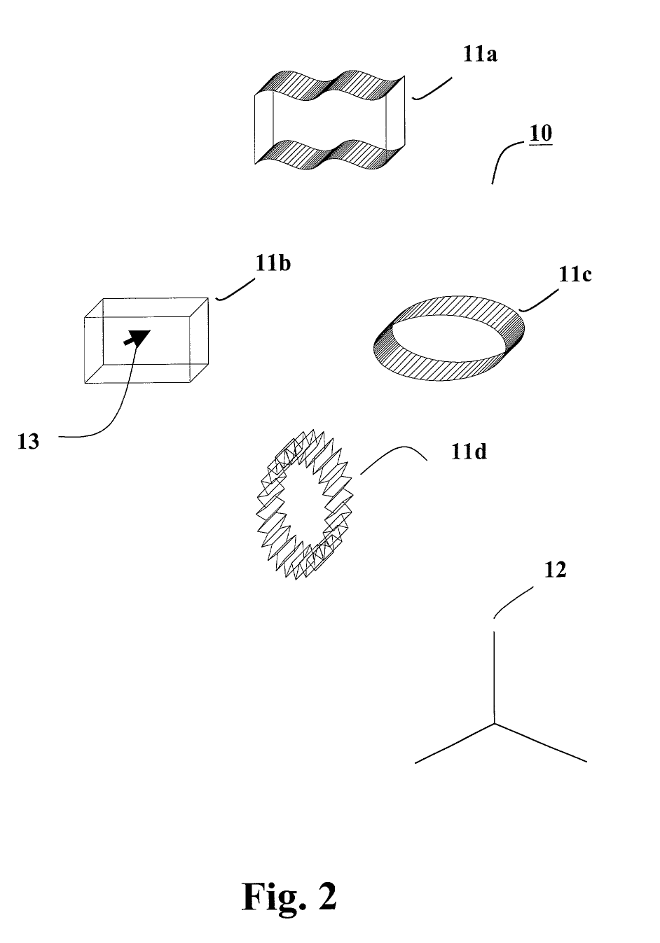

Thus, as exemplified in FIG. 2, an advertisement method 10 on a network comprises displaying a plurality of advertisement objects 11a, 11b, 11c, and 11d in a virtual three-dimensional area 12. A user is allowed to select at least one of the plurality of advertisement objects by clicking on object 11b (indicated by reference number 13).

As will be further explained below, the advertisement object can be anything that an advertiser might want to advertise, including but not limited to, food, cars, consulting service, and others. Virtual three-dimensional area can also be created in a variety of way, but just as an example, the environment could be one in which a perspective view is created on a display and the area can be scrolled from one direction to another or the environment could be one in which a perspective view is created so that a user sees what a person might see entering into a room with the various rooms being entered into and exited. Moreover, although the clicking action has been given as an example in the above discussion of FIG. 2, any suitable means may be used by the user to select the advertisement objects (including but not limited to operating a joystick or a pen).

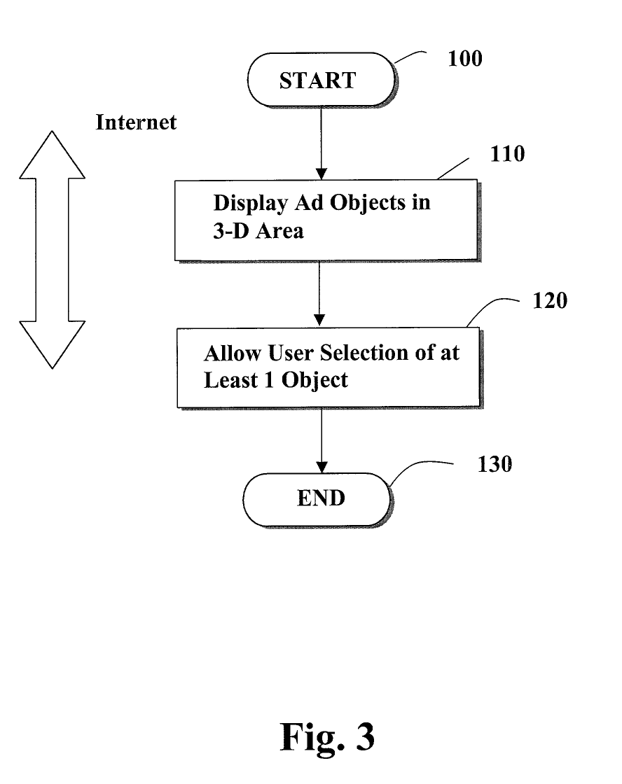

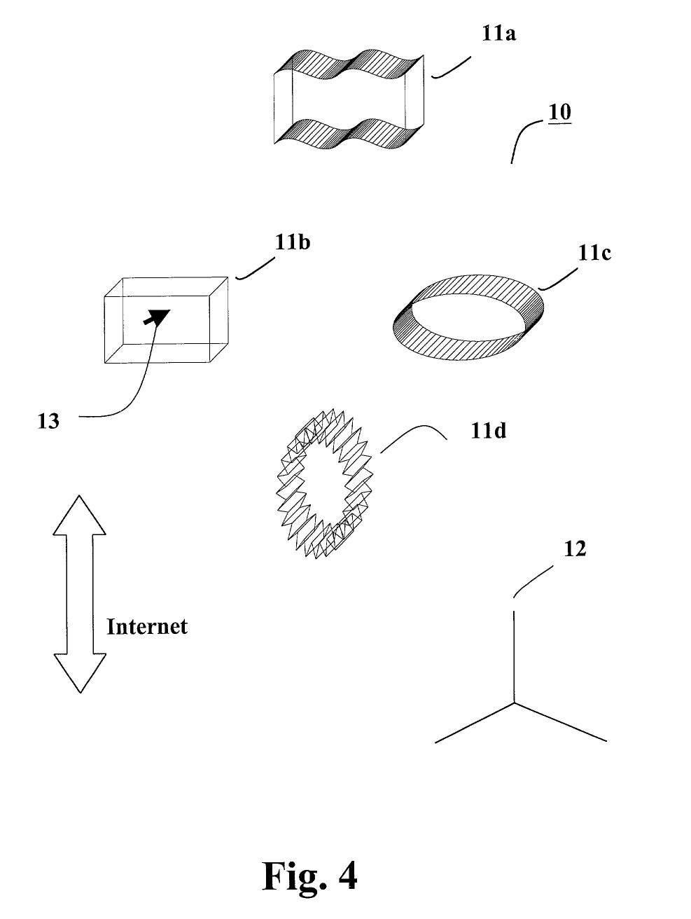

The network may be the Internet (as shown in FIGS. 3 and 4), an Intranet, or another type network. Also, the information may be maintained in a database, or other form of storage (such as a CD-ROM) and may be accessible by users via the network.

In another embodiment of the present invention, as exemplified in FIG. 3, an advertisement method on a network comprises displaying a plurality of advertisement objects in a virtual three-dimensional area at step 110, and allowing a user to select at least one of the plurality of advertisement objects at step 120, wherein the network is the Internet.

Thus, as exemplified in FIG. 4, an advertisement method 10 on a network comprises displaying a plurality of advertisement objects 11a, 11b, 11c, and 11d in a virtual three-dimensional area 12. A user is allowed to select at least one of the plurality of advertisement objects by clicking on object 11b (indicated by reference number 13), wherein the network is the Internet.

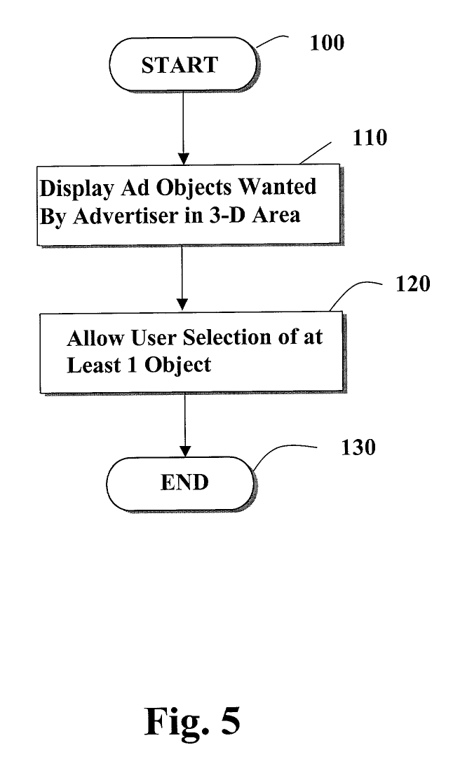

In another embodiment of the present invention, as exemplified in FIG. 5, an advertisement method on a network comprises displaying a plurality of advertisement objects in a virtual three-dimensional area at step 110; and allowing a user to select at least one of the plurality of advertisement objects at step 120; wherein at least one of the plurality advertisement objects comprises information that an advertiser wants to advertise.

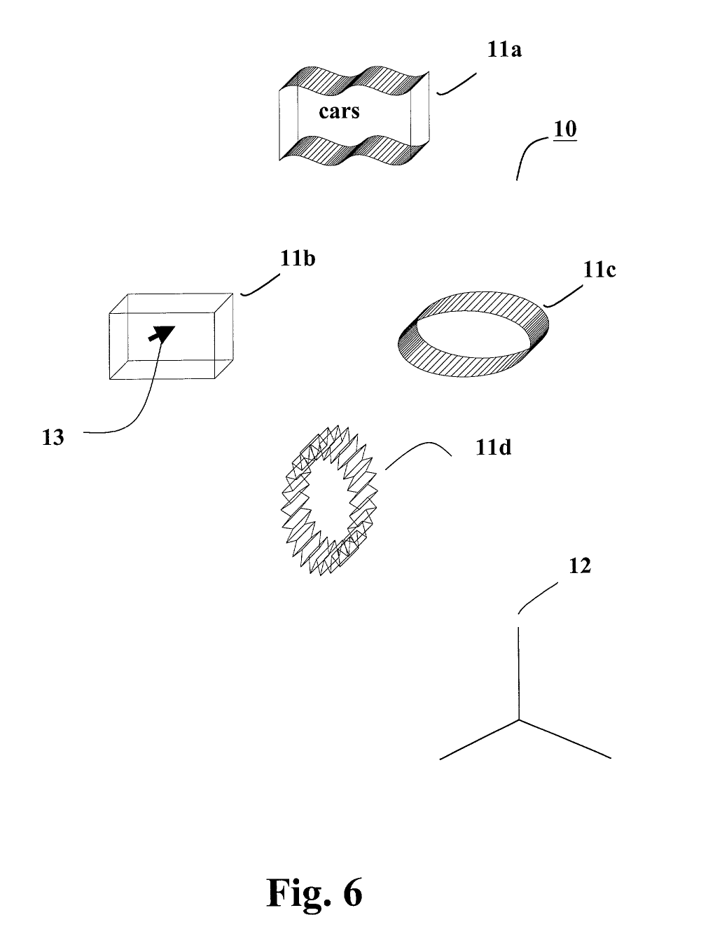

Thus, as exemplified in FIG. 6, an advertisement method 10 on a network comprises displaying a plurality of advertisement objects 11a, 11b, 11c, and 11d in a virtual three-dimensional area 12. A user is allowed to select at least one of the plurality of advertisement objects by clicking on object 11b (indicated by reference number 13). Further, at least one of the plurality advertisement objects comprises information that an advertiser wants to advertise. For example, the information may pertain to cars for advertisement object 11a.

Again, as noted above, the type, quantity, or other characteristics of the information that an advertiser wants to advertise is virtually limitless.

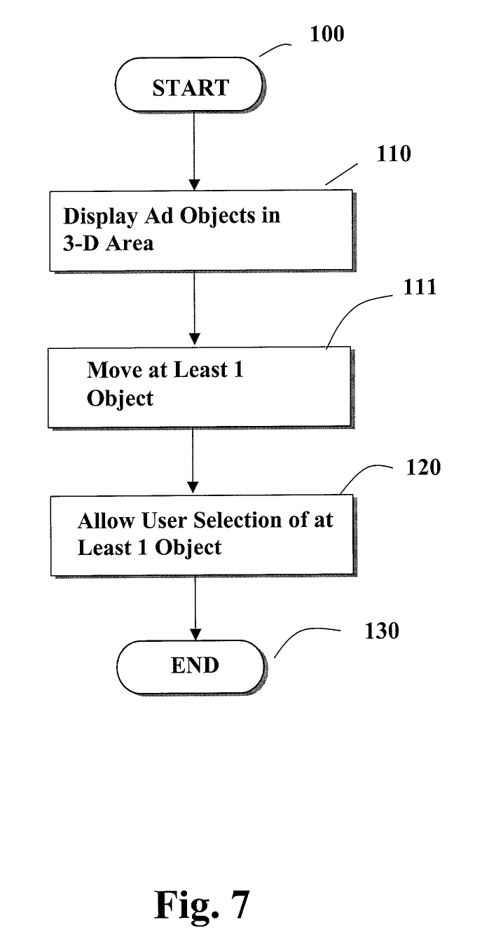

In another embodiment of the present invention, as exemplified in FIG. 7, an advertisement method on a network comprises displaying a plurality of advertisement objects in a virtual three-dimensional area at step 110; allowing a user to select at least one of the plurality of advertisement objects at step 120; and moving at least one of the plurality of advertisement objects in the area at step 111.

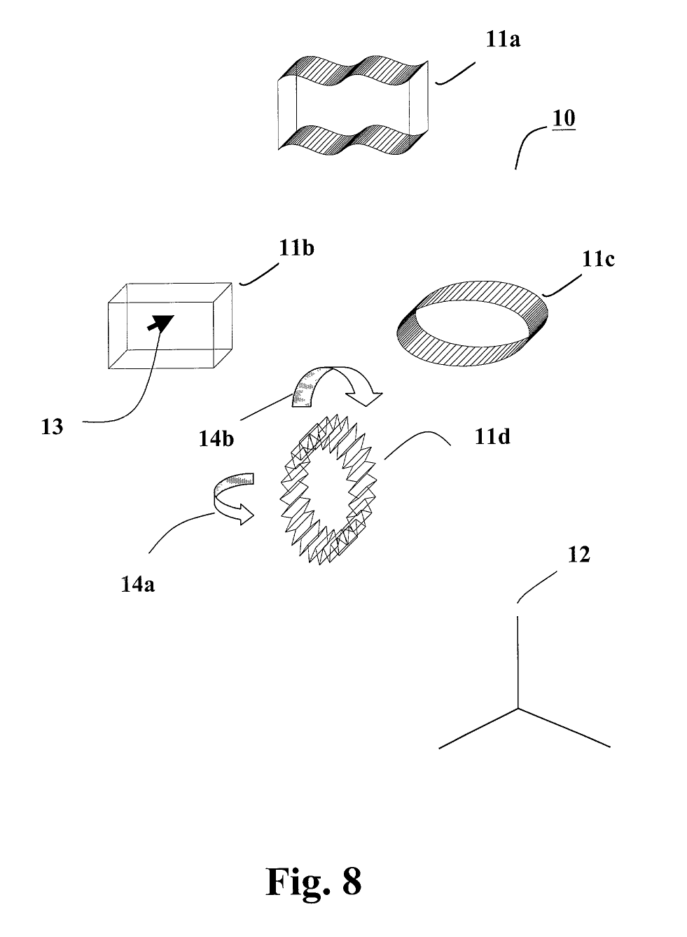

Thus, as exemplified in FIG. 8, an advertisement method 10 on a network comprises displaying a plurality of advertisement objects 11a, 11b, 11c, and 11d in a virtual three-dimensional area 12. A user is allowed to select at least one of the plurality of advertisement objects by clicking on object 11b (indicated by reference number 13). Further, at least one of the plurality of advertisement objects in the area, such as object 11d, may be moved. In this example, the object 11d may be moved in directions indicated by arrows 14a and 14b. Of course, the objects may be moved in any direction.

Again, the manner, kind, number or other characteristic of the movement of the advertisement object may be varied as needed. The direction arrows 14a and 14b are merely exemplary.

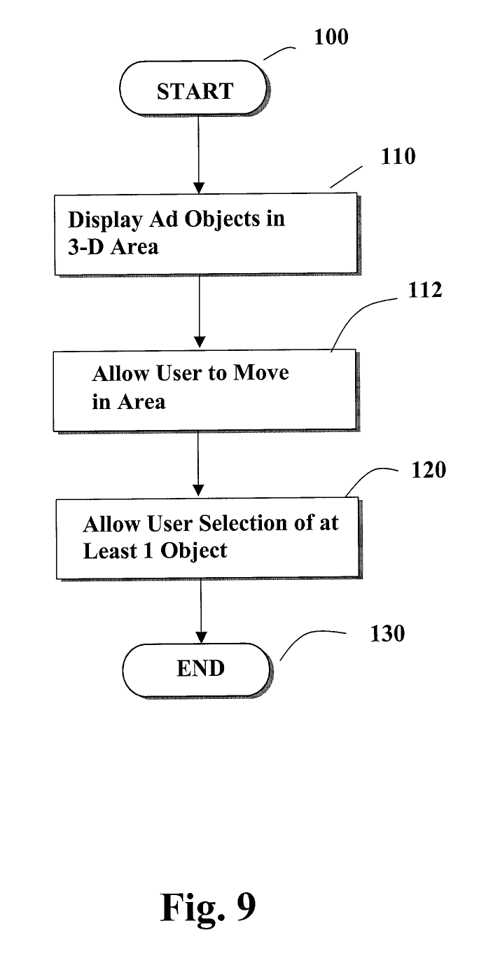

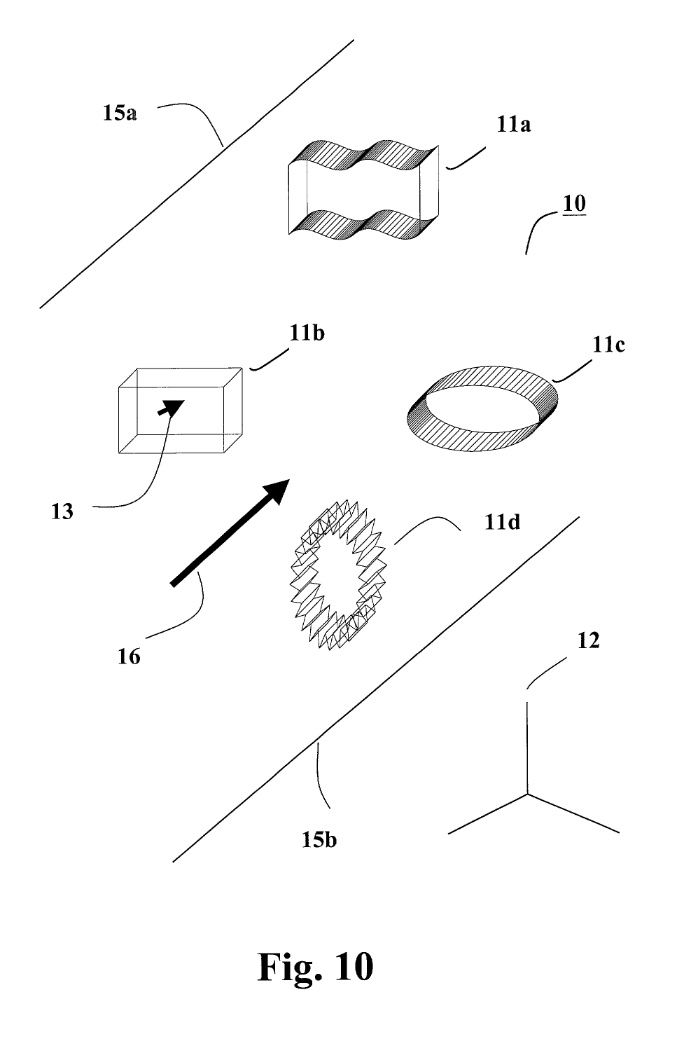

In another embodiment of the present invention, as exemplified in FIG. 9, an advertisement method on a network comprises displaying a plurality of advertisement objects in a virtual three-dimensional area at step 110; allowing a user to select at least one of the plurality of advertisement objects at step 120; and allowing the user to move in the area at step 112.

Thus, as exemplified in FIG. 9, an advertisement method 10 on a network comprises displaying a plurality of advertisement objects 11a, 11b, 11c, and 11d in a virtual three-dimensional area 12. A user is allowed to select at least one of the plurality of advertisement objects by clicking on object 11b (indicated by reference number 13). Further, the user may be allowed to move in the area 12 in any direction. Just as an example, the user may be allowed to move in a direction indicated by arrow 16 within an area defined by boundaries 15a and 15b.

Of course, the user may be move in any direction and the boundaries of the area may be defined in any way. Also, the particular movement of the user may depend on the type of virtual reality created (as briefly noted above).

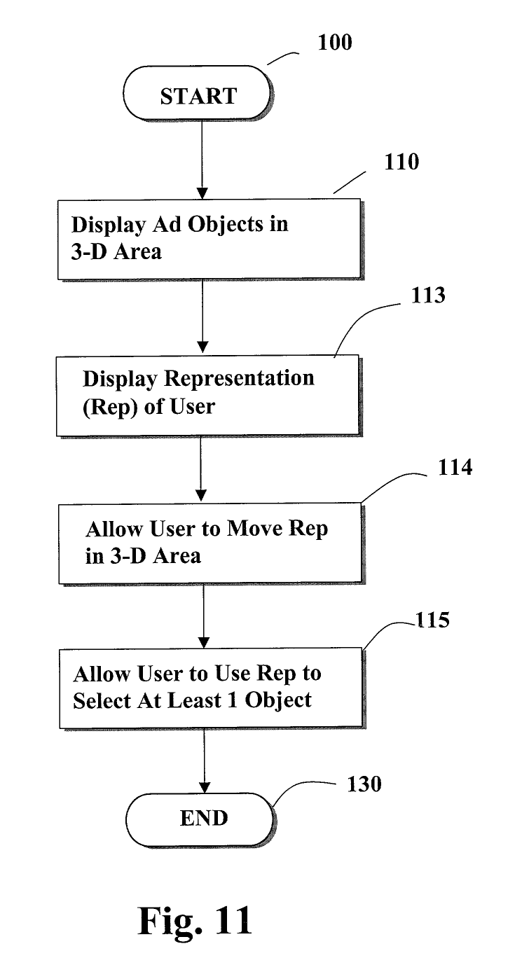

In another embodiment of the present invention, as exemplified in FIG. 11, an advertisement method on a network comprises displaying a plurality of advertisement objects in a virtual three-dimensional area at step 110; and displaying a representation of the user at step 113, wherein the representation can be used by the user to move around in the area at step 114 and to select the at least one of the plurality of advertisement objects at step 115.

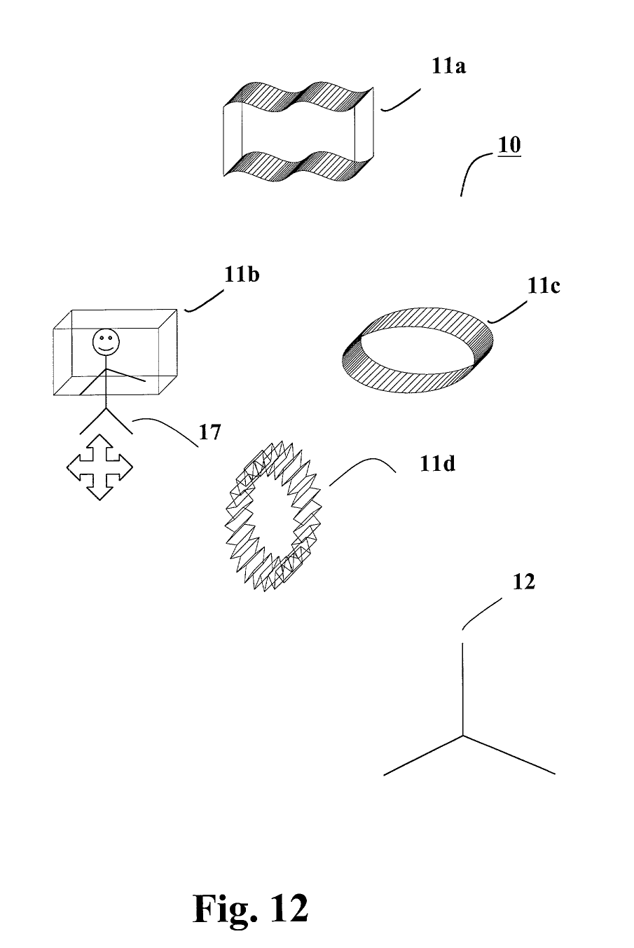

Thus, as exemplified in FIG. 12, an advertisement method 10 on a network comprises displaying a plurality of advertisement objects 11a, 11b, 11c, and 11d in a virtual three-dimensional area 12. Further, a representation 17 of the user is displayed. The representation (or avatar) of the user may be used by the user to move around in the area and to select at least one of the plurality of advertisement objects by any suitable means. Just as an example, clicking on the mouse when the representation 17 is lying over the advertisement object 11b may allow selection.

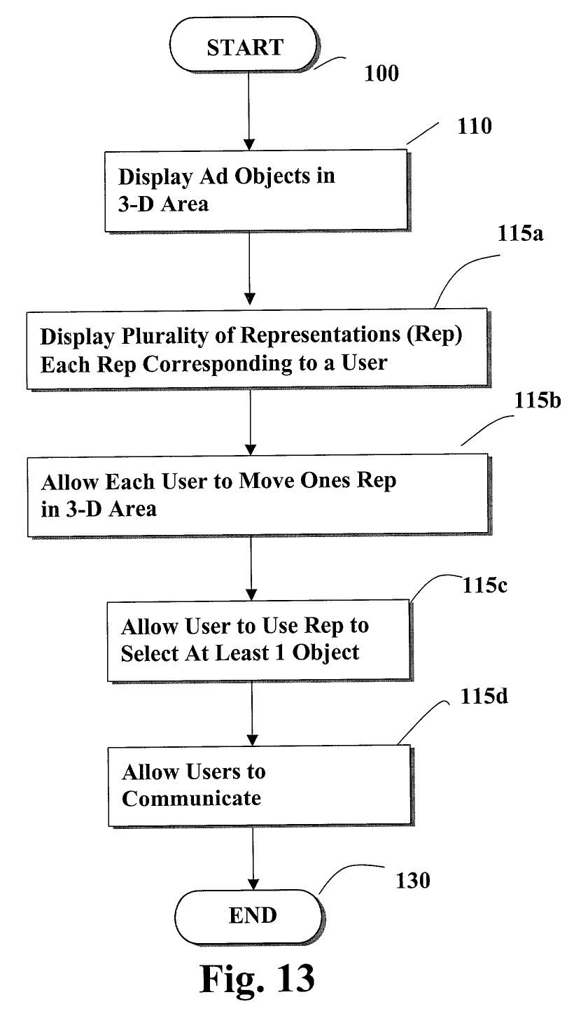

In another embodiment of the present invention, as exemplified in FIG. 13, an advertisement method on a network comprises displaying a plurality of advertisement objects in a virtual three-dimensional area at step 110; and displaying a plurality of representations at step 115a, wherein each one of the plurality of representations corresponds to a respective one of a plurality users, and wherein each one of the plurality of representations can be used by a respective one of the plurality of users to move around in the area at step 115b, to select at least one of the plurality of advertisement objects at step 115c, and to communicate with another one of the plurality of users at step 115d.

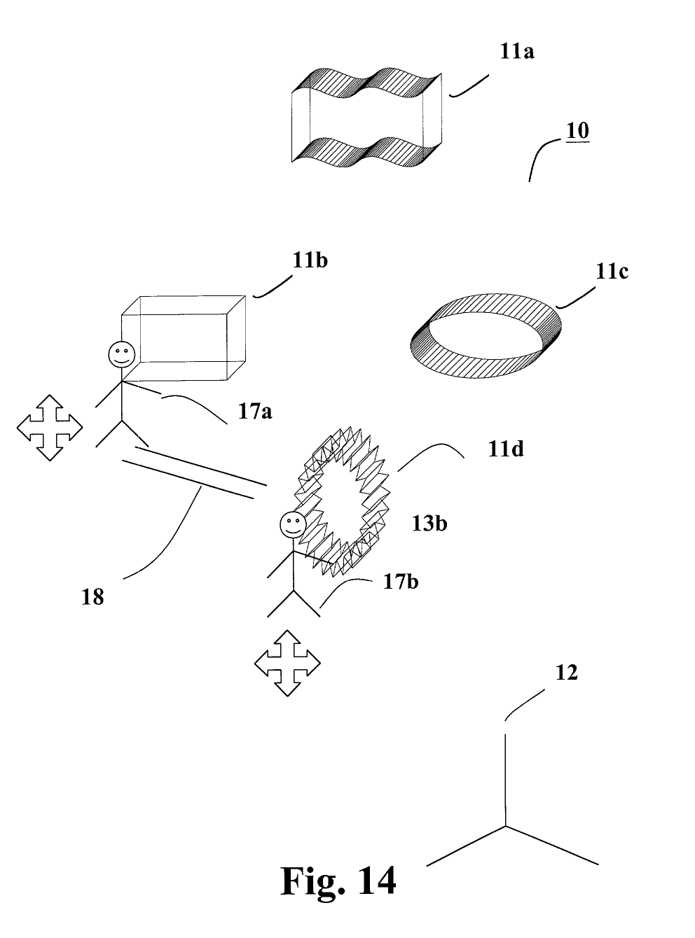

Thus, as exemplified in FIG. 14, an advertisement method 10 on a network comprises displaying a plurality of advertisement objects 11a, 11b, 11c, and 11d in a virtual three-dimensional area 12. Further, a plurality of representations 17a and 17b are displayed, wherein each one of the plurality of representations corresponds to a respective one of a plurality users. Each one of the plurality of representations can be used by a respective one of the plurality of users to move around in the area (as indicated, for example, by the arrow) and to select at least one of the plurality of advertisement objects by any suitable means. Just as an example, clicking on the mouse when the representation 17a or 17b is lying over the advertisement object 11b or object 11d, respectively, may allow selection. Also, each one of the plurality of representations can be used by a respective one of the plurality of users to communicate with another one of the plurality of users. Just as an example, 17a and 17b may be used by their respective users to communicate with the other user (as indicated by reference number 18).

The type, manner, and other characteristics of the communication may vary as needed. Just as an example, the communication may be had by entering text in an area and receiving and reading the respond in the same area (by perhaps adding another window area).

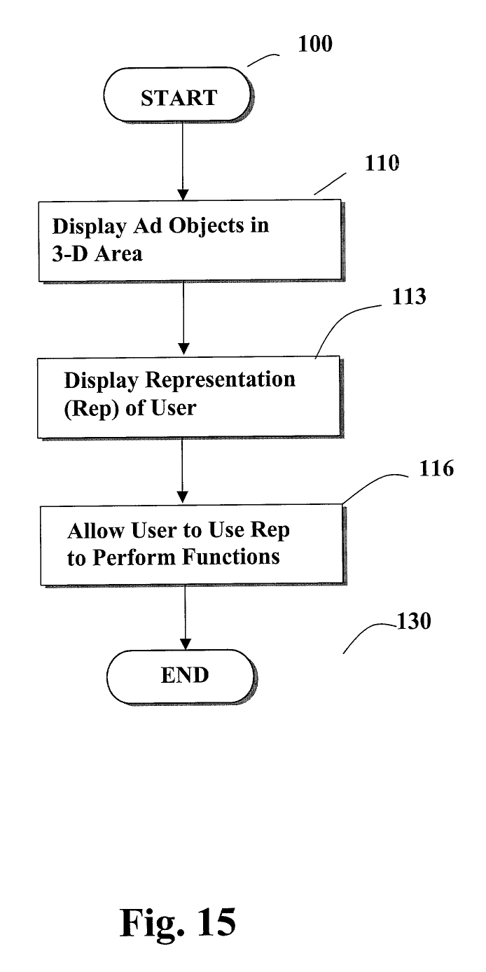

In another embodiment of the present invention, as exemplified in FIG. 15, an advertisement method on a network comprises displaying a plurality of advertisement objects in a virtual three-dimensional area at step 110; and displaying a representation of the user at step 113, wherein the representation can be used by the user to perform a plurality of functions at step 116.

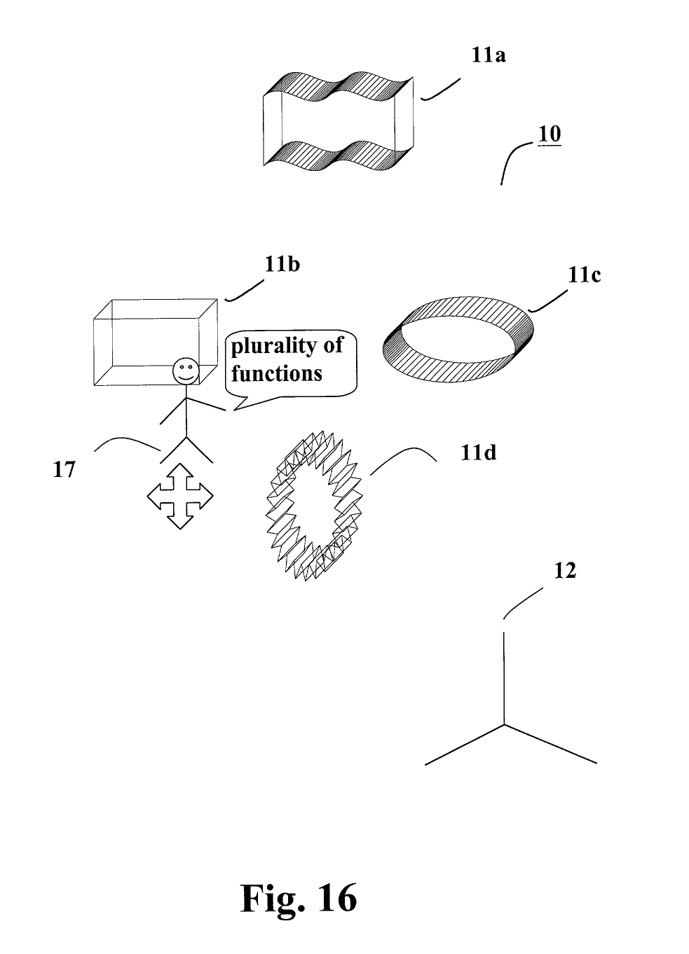

Thus, as exemplified in FIG. 16, an advertisement method 10 on a network comprises displaying a plurality of advertisement objects 11a, 11b, 11c, and 11d in a virtual three-dimensional area 12. Further, a representation 17 of the user is displayed. The representation of the user may be used by the user to perform a plurality of functions. Just as an example, a function may include moving the representation around in the area in any direction (for example, as indicated by the arrow) and selecting at least one of the plurality of advertisement objects by any suitable means. Just as an example, clicking on the mouse when the representation 17 is lying over the advertisement object 11b may allow selection.

Of course, the type, manner, and other characteristics of the function may be varied as needed.

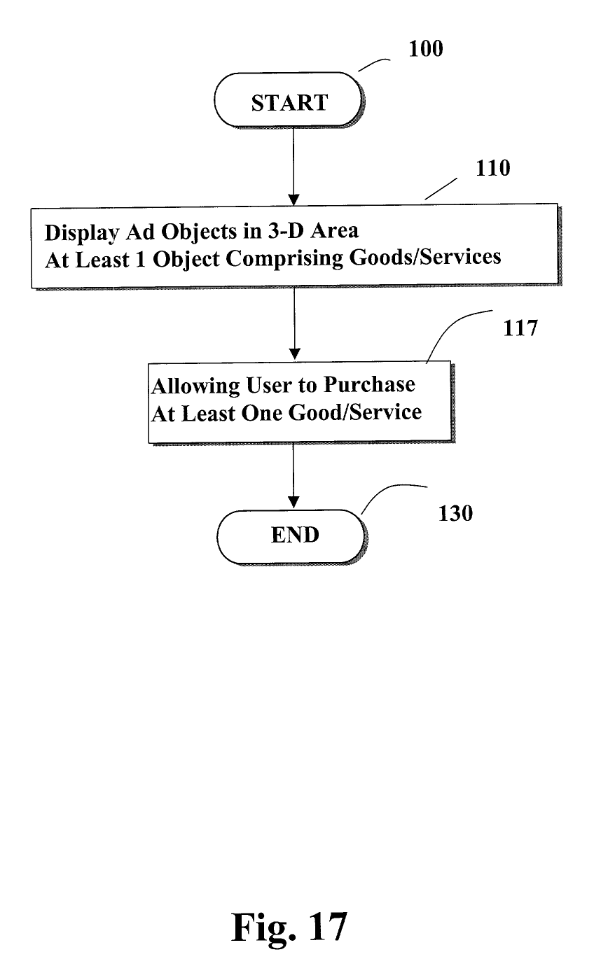

In another embodiment of the present invention, as exemplified in FIG. 17, an advertisement method on a network comprises displaying a plurality of advertisement objects in a virtual three-dimensional area at step 110, wherein at least one of the plurality advertisement objects comprises a plurality of goods or services. The method further comprises allowing the user to purchase at least one of the plurality of goods or services at step 117.

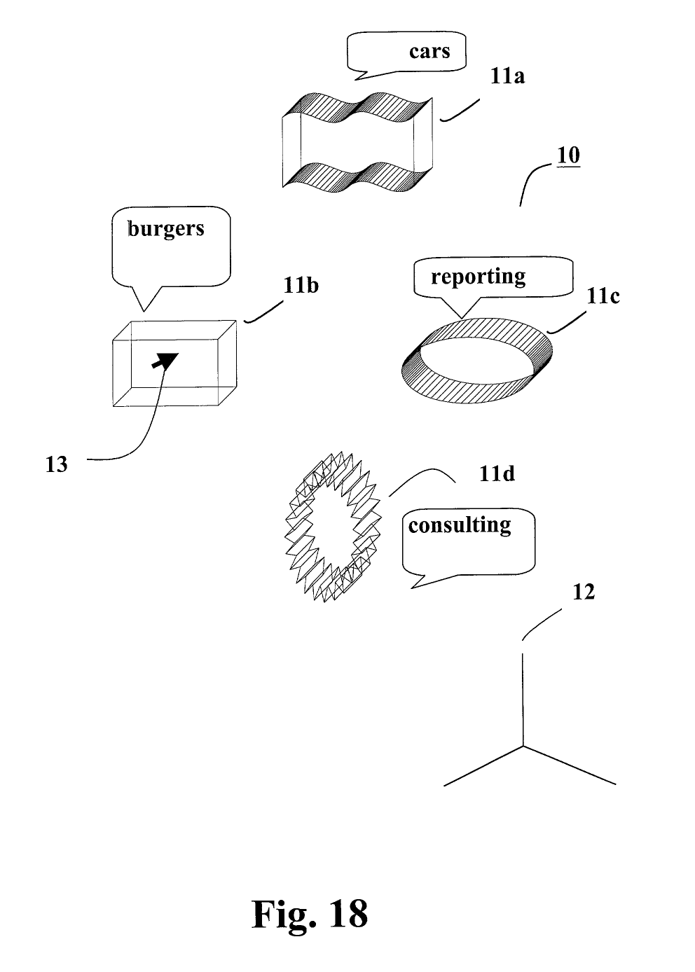

Thus, as exemplified in FIG. 18, an advertisement method 10 on a network comprises displaying a plurality of advertisement objects 11a, 11b, 11c, and 11d in a virtual three-dimensional area 12, wherein at least one of the plurality advertisement objects comprises a plurality of goods or services. In this example, advertisement object 11a comprises information pertaining to cars; 11b to burgers; 11c to reporting services; and 11d to consulting services. The method further comprises allowing the user to purchase at least one of the plurality of goods or services. In this example, object 11b is selected (as indicated, for example, by reference number 13).

Again, the manner of selection may be varied as needed.

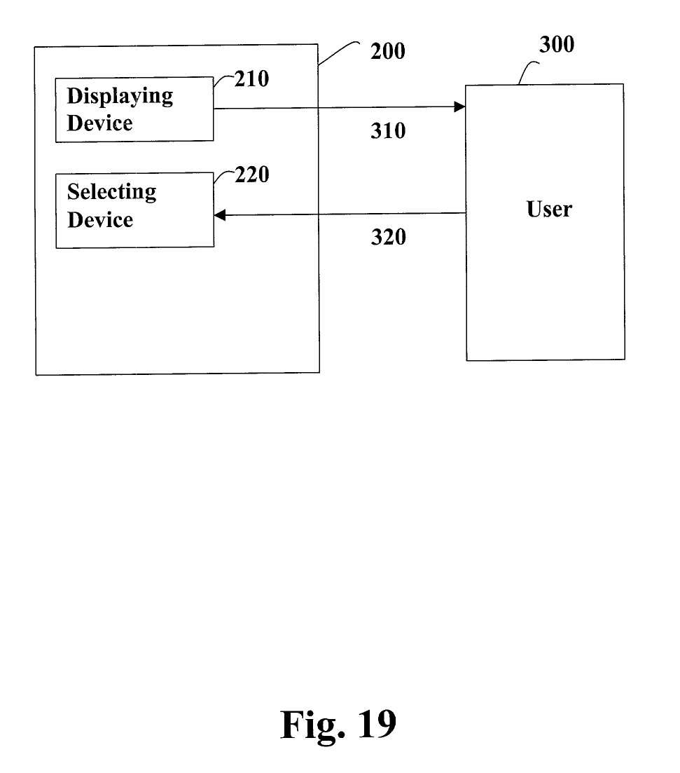

In another embodiment of the present invention, as exemplified by FIG. 19, an advertising apparatus on a network 200 comprises a means for displaying a plurality of advertisement objects in a virtual three-dimensional area 210, and a means for allowing a user to select at least one of the plurality of advertisement objects 220. The user 300 may transmit information to and from apparatus 200, for example, via paths 310 and 320.

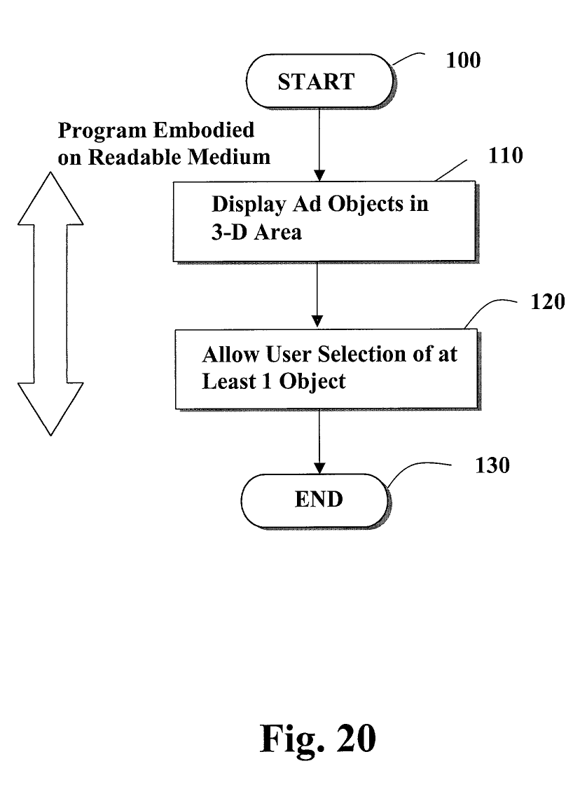

In another embodiment of the present invention, as exemplified in FIG. 20, a computer program stored on a computer-readable medium comprises the instructions of displaying a plurality of advertisement objects in a virtual three-dimensional area at step 110; and allowing a user to select at least one of the plurality of advertisement objects at step 120.

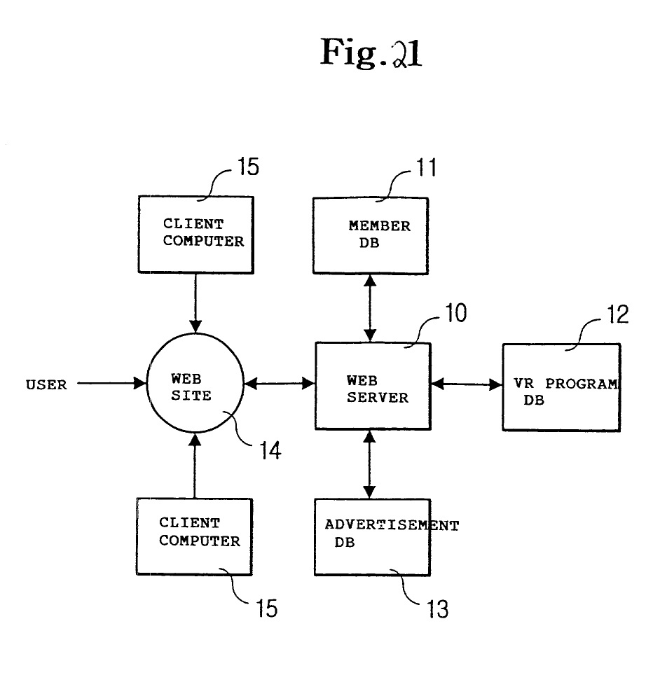

FIG. 21 is a block diagram showing the construction of the Internet advertisement system in accordance with another embodiment of the present invention. Referring to FIG. 21, a Web server 10 is configured to operate a variety of programs on a website 14 in the form of games or shopping malls using a three-dimensional virtual reality technique based on a perspective representation manner. The website 14 is accessible by general users using client computers 15 connected to the Internet.

Connected to the Web server 10 are a virtual reality (VR) program database (DB) 12, advertisement DB 13 and member DB 11. The VR program DB 12 is adapted to store a plurality of three-dimensional virtual reality programs to be provided to all netizens connected to the website 14. The advertisement DB 13 is adapted to store three-dimensional advertisement information about a variety of products and services requested to be advertised by advertisers. The member DB 11 is adapted to store information regarding avatars and identities of members. The avatars are alter ego characters of the respective members, which act on behalf of them in the three-dimensional virtual reality spaces according to the three-dimensional virtual reality programs stored in the VR program DB 12. The Web server 10 is adapted to move virtual Web signboards, virtual Web ad-balloons and virtual Web shops in a three-dimensional perspective representation manner with the movement of an alter ego character of a given user within a selected one of the virtual reality spaces as if they were really present around the character. The virtual Web signboards, virtual Web ad-balloons and virtual Web shops are sold or leased to the advertisers so that they can represent the advertisement information stored in the advertisement DB 13 in the three-dimensional graphics according to the conditions agreed upon by an operator of the website 14 and the respective advertisers.

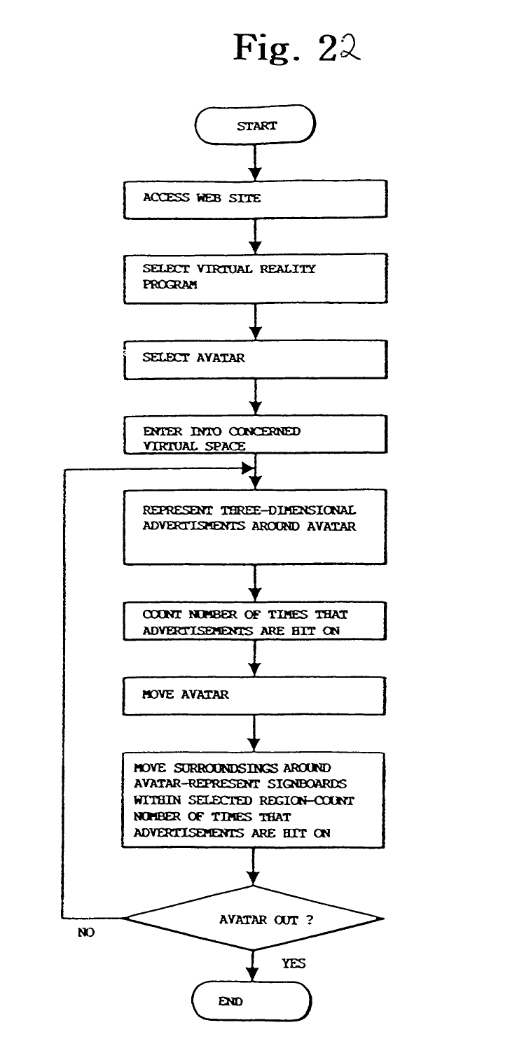

Now, a detailed description will be given of the operation of the Internet advertisement system with the above-mentioned construction according to the present invention with reference to FIGS. 21 through 23c.

A user of the client computer 15 logs in, accesses the relevant website 14 on the Internet, and requests the Web server 10 of an authorization to use the website. The Web server 10 determines on the basis of the member information stored in the member DB 11 whether to authorize the user to enter the website for use. Such a process for authorization is performed in a limited manner only when a netizen attempts to gain access to a special operation program, for example, an operation program under a membership system. If necessary, the authorization process may be deleted.

Thereafter, the user accesses a desired one of the virtual reality programs stored in the VR program DB 12 under the authorized or free use and then selects a desired mode and a desired avatar. The selected avatar is an alter ego character of the user to act on behalf of him or her in a selected virtual reality space based on the accessed virtual reality program.

After the selected avatar enters into the selected virtual reality space, all virtual geographical features and other characters are arranged around the selected avatar in the center. Here, the other characters are those other than the selected avatar, for the alter egos of other users connected to the website. The virtual geographical features include buildings, shops, ad-balloons, standing signboards, electric signs, directional signboards, performance halls, classrooms for study, etc.

If the user's avatar and the other's avatar are close to each other, they can perform graphic-based real-time chatting in the virtual reality space to converse with each other.

The various geographical features or others' avatars disposed in the virtual space adjacent to the user's avatar in the center are displayed in a limited manner. That is, the display is defined by the size of a window on the monitor screen of the client computer.

Thus, as the selected avatar moves, several things or characters adjacent thereto are displayed on the monitor screen of the client computer. At the same time, advertisements in a variety of types are represented in the standing signboards, electric signs or ad-balloons appearing around the selected avatar in the center. Such advertisements are tailored according to the order from the advertisers.

The objects for posting advertisements, such as three-dimensional signboards or ad-balloons formed within the virtual space, can be sold or leased to the advertisers.

The advertisers can plan and create advertisements at their disposal in the leased or purchased signboards, etc. under the agreed conditions, thereby freely and effectively representing features or characteristics of their commodities or services. Particularly, since the advertisement DB 13 includes advertisement data created by the advertisers, the relevant advertisements are represented in the signboards or ad-balloons as being hit on with the movement of the avatar character.

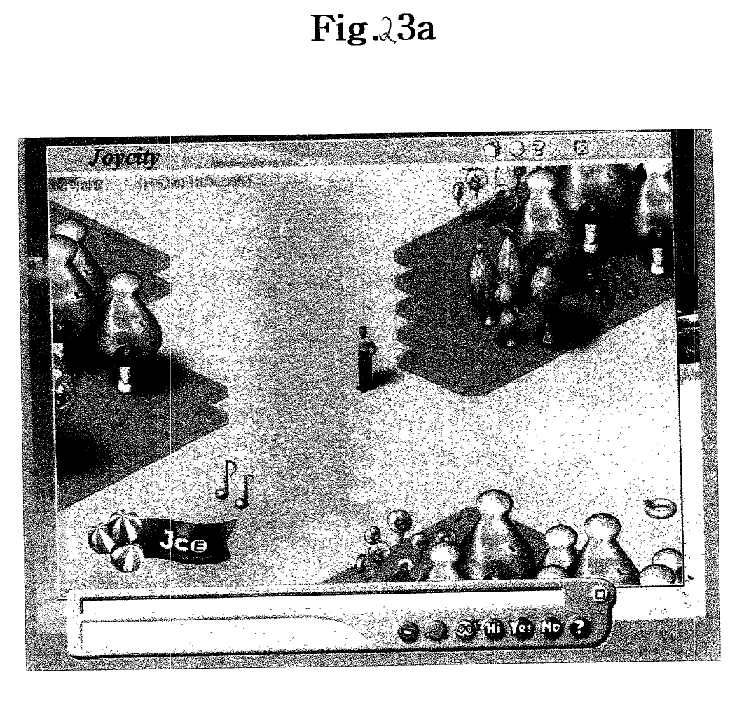

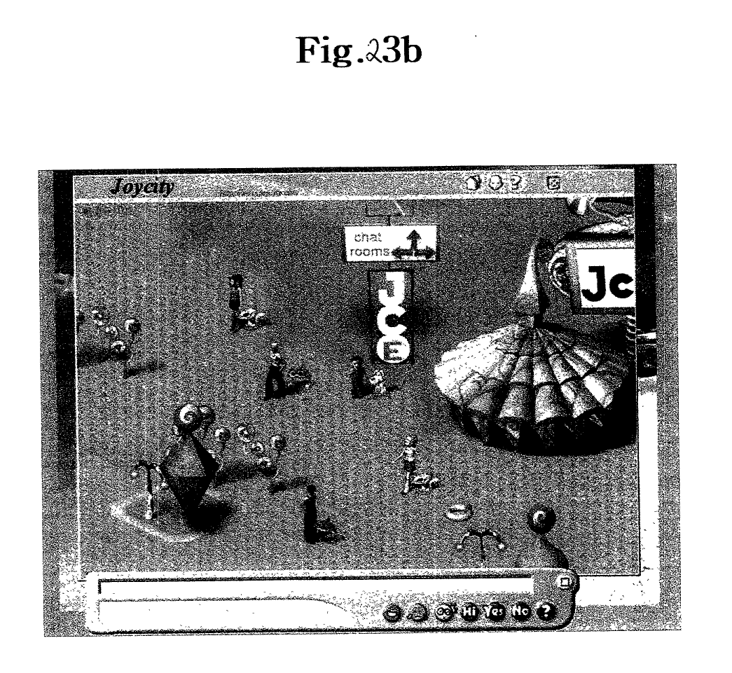

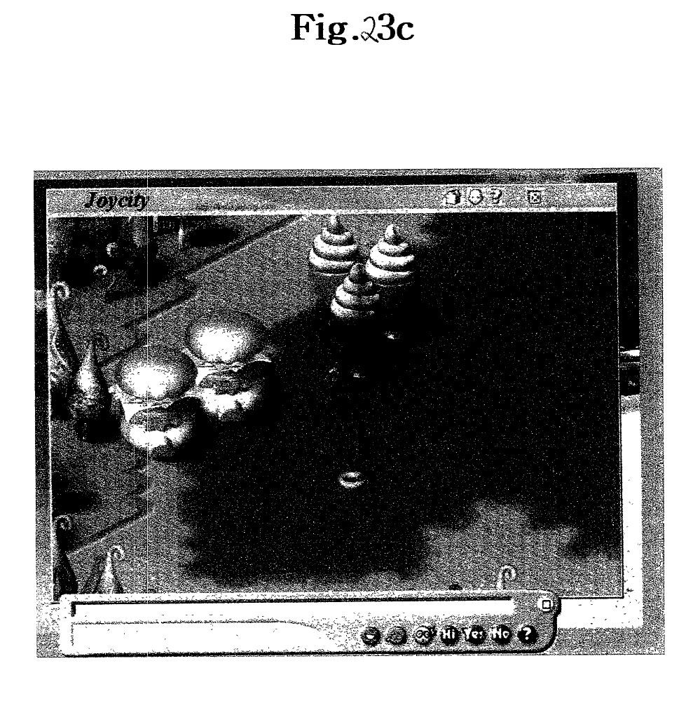

FIG. 23a is a view showing an exemplary picture displayed on the monitor screen of the client computer, wherein the user's avatar enters into a music town among several towns in the virtual space. Referring to this figure, a word “Jce” to advertise is represented in an ad-balloon in the left lower part of the screen.

In the advertisement DB 13, the number of times that the relevant advertisement is displayed around the avatar is stored. The Web server 1 can be configured to count the number of times that the advertisement is joined.

Referring to FIG. 23c, ice creams and hamburgers much exaggerated in comparison of other objects therein are positioned around the avatar character in the center. Commodity advertisements or trademarks of their manufacturer or merchandiser are attached to given regions in the ice creams and hamburgers. Such a three-dimensional-advertisement technique is unique and up-to-date in comparison of the conventional advertisement techniques.

Referring to FIG. 23b, the avatar character illustrated in FIG. 23a is located in an amusement park in the virtual space. Road signs, standing signboards, electric signs (only a part of which is represented in the right upper part on the screen), etc. are positioned around the avatar in the center.

The other characters, the signboards, etc. can be moved in three-dimensions and in perspective representation to gradually become close or distant, by which the contents advertised in the signboards, etc. attract the user's attention and can be naturally and smoothly kept in the memory of the user who is the self of the avatar.

If the avatar moves to a shopping town and further enters into a shop, it can purchase a product or some products sold in that shop.

For example, if the avatar enters into a grocery, a variety of articles of food as exhibited are displayed on an associated page. The avatar selects any one of the food articles and pays the cyber money therefor, by which deficiency or all of the energy source for survival of the avatar can be supplied.

In the same manner, if the user desires to buy a music record and/or tape, he or she can first direct the selected avatar to enter into a music shop, purchase the desired record and/or tape, and pay for it with the cyber money. Therefore, the purchased record and/or tape satisfy the user's desire rather than the avatar itself.

Further, the user is allowed to make the avatar enter into a dance classroom to teach the avatar how to dance and pay the tuition fee. Then, the user can direct the avatar to dance as taught.

In terms of the client computer's user, a three-dimensional portal site can be constructed with all the activities of the avatar in the virtual space according to the present invention.

As apparent from the above description, three-dimensional virtual reality programs are provided through an Internet home page, and virtual Web signboards, virtual Web ad-balloons and virtual Web shops move in a three-dimensional perspective representation manner with the movement of a specific character within a selected virtual reality space as if they were really present around the character. Therefore, customers can have a higher respectable degree of recognition of advertisements on the Internet.

Further, advertisement posting elements such as three-dimensional signboards, ad-balloons or shops depicted in virtual reality spaces are sold or leased to any advertisers who wish to plan and create advertisements at their disposal under the conditions agreed upon by an associated site operator and the respective advertisers. Therefore, the advertisers can freely and effectively represent features and characteristics of their products or services.

Moreover, the user can visit his or her desired location or site by moving the avatar under the three-dimensional background, thereby making it possible to construct a portal site using the three-dimensional virtual space.

Although the preferred embodiments of the present invention have been disclosed for illustrative purposes, those skilled in the art will appreciate that various modifications, additions and substitutions are possible, without departing from the scope and spirit of the invention as disclosed in the appended claims.

What is claimed is:

1. An advertisement method on a network, comprising:
displaying a plurality of advertisement objects in a virtual three-dimensional area; and
allowing a user to select at least one of said plurality of advertisement objects.

2. A method according to claim 1, wherein said network is the Internet.

3. A method according to claim 1, wherein said at least one of said plurality advertisement objects comprises information that an advertiser wants to advertise.

4. A method according to claim 1, further comprising the following step:
moving at least one of said plurality of advertisement objects in said area.

5. A method according to claim 1, further comprising the following step:
allowing said user to move in said area.

6. A method according to claim 1, further comprising the following step:
displaying a representation of said user, wherein said representation can be used by said user to move around in said area and to select said at least one of said plurality of advertisement objects.

7. A method according to claim 1, further comprising the following step:
displaying a plurality of representations, wherein each one of said plurality of representations corresponds to a respective one of a plurality users, and wherein each one of said plurality of representations can be used by a respective one of said plurality of users to move around in said area, to select said at least one of said plurality of advertisement objects, and to communicate with another one of said plurality of users.

8. A method according to claim 1, further comprising the following step:
displaying a representation of said user, wherein said representation can be used by said user to perform a plurality of functions.

9. A method according to claim 1, wherein said at least one of said plurality advertisement objects comprises a plurality of goods or services, further comprising the following step:
allowing said user to purchase at least one of said plurality of goods or services.

10. An advertising apparatus on a network, comprising:
means for displaying a plurality of advertisement objects in a virtual three-dimensional area; and
means for allowing a user to select at least one of said plurality of advertisement objects.

11. A computer program stored on a computer-readable medium, comprising the instructions of:
displaying a plurality of advertisement objects in a virtual three-dimensional area; and
allowing a user to select at least one of said plurality of advertisement objects.

12. An Internet advertisement system using virtual reality spaces based on three-dimensional graphics, comprising:
a virtual reality program database for storing a plurality of three dimensional virtual reality programs to be provided to a website;
an advertisement database for storing three-dimensional advertisement information about a variety of products and services requested to be advertised by advertisers; and
a Web server for providing said three-dimensional virtual reality programs stored in said virtual reality program database to said website to allow avatar characters of users participating in said virtual reality programs to act in virtual reality spaces defined respectively by said virtual reality programs and for moving virtual Web signboards, virtual Web ad-balloons and virtual Web shops in a three-dimensional perspective representation manner with the movement of said avatar characters within said virtual reality spaces as if they were really present around said avatar characters.

13. An Internet advertisement system according to claim 12, wherein said virtual Web signboards, Web ad-balloons and Web shops are sold or leased to the advertisers so that they can represent the advertisement information stored in said advertisement database as being hit on with the movement of said avatar characters.

14. An Internet advertisement system according to claim 12, wherein said advertisement database is further adapted to store information about the number of times that advertisements are represented in said signboards, ad-balloons and shops as being hit on with the movement of said avatar characters.

15. An Internet advertisement system according to claim 12, wherein said Web server includes a member database for storing information regarding avatars and identities of members.
